(19) United States
(12) Patent Application Publication
(10) Pub. No.: US 2013/0202828 A1
(43) Pub. Date: Aug. 8, 2013

(54) Laser Thermal Printing on Microporous Plastic Substrates

(71) Applicant: Philip Jacoby, Marietta, GA (US)

(72) Inventor: Philip Jacoby, Marietta, GA (US)

(73) Assignee: Mayzo Corporation, Norcross, GA (US)

(21) Appl. No.: 13/755,433

(22) Filed: Jan. 31, 2013

Related U.S. Application Data
(60) Provisional application No. 61/595,211, filed on Feb. 6, 2012.

(51) Int. Cl. B29C 59/16; B32B 3/26; B32B 33/00

(52) U.S. Cl. CPC B29C 59/16; B32B 33/00; B32B 3/26
USPC 428/36.5; 521/142; 264/482; 428/221; 428/315.5

(57) ABSTRACT

Disclosed herein is a process for printing on a microporous substrate using a laser to melt or soften the substrate so that the pores collapse and produce clear regions on a white background. The preferred substrate is one based on polypropylene where the microvoids are produced by orienting an extruded, precursor sheet that contains the beta crystalline form of polypropylene. A dark co-extruded layer or a pigmented adhesive can be placed on the non-laser treated side of the film, so that the treated side shows the color of the backing layer through the clear regions. This type of printing or laser marking does not require any inks, solvents, or other consumable additives, and the printing can be done at very high production rates and at low cost. The small void size of the film allows for fine print detail and excellent print contrast.

### CROSS REFERENCED TO RELATED APPLICATIONS

This application claims priority upon U.S. provisional application Ser. No. 61/595,211 filed Feb. 6, 2012. This application is hereby incorporated by reference in its entirety for all of its teachings.

### BACKGROUND

The present disclosure relates to a method for producing clear transparent print on opaque, microporous plastic substrates using laser thermal printing without the use of any inks or pigments.

Printing on plastics is much more difficult than printing on paper, and many variables need to be tightly controlled so that the ink adheres to the plastic substrate without peeling off. These variables include controlling the surface free energy of the plastic so that it is high enough that the ink will adhere to the plastic substrate and dry without peeling off, but not too high since this can lead to static buildup in the printing press. Printing is particularly difficult with low surface energy materials such as the polyolefins including polyethylene and polypropylene. In order to raise the surface energy of these polyolefins to get better ink adhesion, the plastic substrate must be either corona treated or flame treated so that the surface becomes oxidized. It is also crucial that the surface oxidation be uniform so that the print quality does not vary across the surface of the printed film. The formulation of the ink is also important since it must be possible to cure and dry the ink in as short a time period as possible in order to have high productivity.

It would be desirable to print on opaque polymer substrates without the use of inks. Such non-ink printing would eliminate the need for the ink and the solvent, as well as eliminating the need to pre-treat the surface of the substrate to improve the adhesion of the ink. Although thermal printers have been used for this purpose, they still require the use of special papers, chemicals, and printing equipment, and thermal printing is not generally used on polymer substrates. Lasers have been used to mark polymers, but this marking effect is quite different from printing. The laser marking process burns away a portion of the polymer surface and would not be suitable for thin films. Also, laser marking does not produce a strong contrast between the marked and non-marked areas, and would not replace conventional ink-based printing.

### SUMMARY

Disclosed herein is a process of producing clear transparent print or dark colored print on a white/opaque plastic substrate without the use of inks, and without having to apply any surface treatment to the polymer substrate. This substrate must not contain any fillers or light scattering pigments, and the source of the opacity of this substrate must be solely due to the presence of microvoids in the plastic substrate. These microvoids may be produced using a number of different techniques. These techniques include microcellular foaming such as that used in the Mucell process, and beta nucleation which is used in propylene-based polymer substrates. Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is understood that both the foregoing general description and the following detailed description are exemplary and explanatory only and are not restrictive of the invention, as claimed.

### BRIEF DESCRIPTION OF THE DRAWINGS

The accompanied drawings which are incorporated in and constitute a part of this specification, illustrate several aspects described below.

FIG. 1 is a photograph of a back-lit microporous propylene-based polymer film that has been exposed to various intensities of CO₂ laser. This microporous film was produced using beta nucleation.

FIG. 2 is a photograph of a similar microporous propylene based polymer film that has been exposed to the CO₂ laser and then this film was marked with a black marker pen over the laser-exposed region.

FIG. 3 is a photograph of the reverse side of the film shown in FIG. 2, where the black color of the ink from the marking pen shows through the film since the laser-etched region of the film has now become transparent.

FIG. 4 is a photograph of a microporous thermoformed polypropylene cup that has been exposed to the CO₂ laser to produce clear printing on a white background

### DETAILED DESCRIPTION

The Mucell microcellular foam process uses supercritical fluids (SCFs) from atmospheric gases to create evenly distributed, uniformly sized microscopic cells throughout the polymer.

The beta nucleation technique utilizes special crystal nucleation agents to produce the beta crystalline form of polypropylene in extruded sheets and films. Polypropylene can crystallize in one or more of three different crystalline forms known as the alpha, beta, and gamma forms. The alpha phase is the most common and most stable form of polypropylene. Most conventional crystal nucleating agents nucleate only the alpha form of polypropylene. The beta phase is less common and less thermodynamically stable, but beta crystalline polypropylene has been used to make novel products such as microporous oriented films and microporous thermoformed containers. These microporous structures are produced when the extruded sheet is stretched in the solid state below the melting point of the beta crystal phase. During the stretching process the beta crystals transform into alpha crystals and simultaneously produce microvoids that are typically less than one micron in size. In the production of microporous films, this stretching can be done either uniaxially or biaxially. In the production of thermoformed containers, multiaxial stretching occurs due to the effect of a plug impinging on the sheet and the application of air pressure and/or vacuum to draw the softened sheet into the mold cavity.

Since the microvoids that are produced by either microcellular foaming or beta nucleation followed by solid state stretching have a size that is on the order of the wavelength of visible light or larger, these microvoids strongly scatter light causing the plastic part to take on a white/opaque appearance. Without the presence of these microvoids the plastic film or part would be clear or transparent in appearance.

Lasers are widely used to etch patterns onto plastic substrates for the purpose of marking these substrates. Lasers can produce very narrow beams of light that can locally heat the plastic substrate thereby melting or vaporizing the plastic it to produce patterns with very fine detail. This technique, however, is not suitable for producing well defined printing that is easily readable on thin substrates, since there is no way to develop high contrast between the printed and non-printed background if the laser etched region does not completely perforate the substrate.

If the substrate contains micropores, however, it would be possible to heat the plastic to a temperature where the pores collapse and the melted plastic becomes non-porous, without creating holes in the regions that are heated by the laser. Typically the pores in a semicrystalline polymer will collapse when the polymer is heated above the melting point of the crystal phase. In the case of an amorphous polymer, the pores will collapse at some temperature above the glass transition temperature of the polymer where the polymer viscosity becomes low enough for viscous flow to occur. In either case, once the pores collapse there will no longer be any discontinuities in the melted area such as microvoids to scatter light, and these regions of the substrate will be relatively clear and transparent when the polymer solidifies. This means that the pattern produced by the laser will appear as a clear, transparent region on a white background. If the white film also contains a dark backing, such as a co-extruded layer with dark pigment in it, or if the microporous film is being used as a label and contains a dark colored adhesive on one side, then the laser heated regions will appear dark on a white background. If this pattern is produced in the sidewall of a thermoformed container that is designed to hold a colored food product such as orange juice, the color of the food product will show through the transparent printed area so that the container appears as if it were printed using inks that are the same color as that of the food product.

If the pre-cursor extruded sheet that is used to make the microporous film or thermoformed container is made by co-extruding an opaque black or other opaque colored layer on one side of the layer that will become microporous, then when the final oriented film or thermoformed container is produced it will be white on the side containing the microporous layer and black or dark colored on the opposite side. If a laser is then used to produce a pattern on the microporous layer of the part, then the pattern produced by the laser will appear black or dark colored on a white back ground since the dark layer will show through the clear etched portions of the white layer. This will give the same appearance as that obtained using conventional printing with dark inks on a white substrate, but without the use of any inks.

Since this method producing printed patterns does not require the use of inks it is not necessary to either corona or flame treat the surface of the plastic substrate in order to make it receptive to inks. Also the use of inks is completely eliminated thereby saving not only the cost of this raw material, but also speeding up the printing process since there is no longer any need for the curing and drying steps. Also, there are no clean-up issues associated with the use of inks. Moreover, since the printed pattern is not produced using inks, this pattern is permanent and cannot be removed by solvents or exposure to harsh environments. For example, laser printed tags can be used in clothing that must be dry cleaned, without any concerns that the dry cleaning solvents will remove the printing on the tags.

### SUMMARY

In accordance with the purpose(s) of the invention, as embodied and broadly described herein, this disclosure, in one aspect, relates to a method of using lasers to print on microporous plastic substrates without the use of inks.

In one aspect, the present disclosure provides for use of lasers to print on microporous oriented polypropylene films and thermoformed polypropylene containers where the microporosity is achieved through the use of beta nucleation.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides for a method of using a laser to print a clear pattern on a white/opaque plastic substrate where the white appearance is due to the presence of microvoids in the substrate, and the printed layer contains no fillers, pigments, or other dispersed phases that contribute to light scattering.

In one aspect of this invention it would be highly advantageous to be able to print a pattern on a microporous polypropylene film or a thermoformed polypropylene container where there are microvoids in the sidewall of the container, so that this printing can be done without the use of inks and without the need to modify the surface free energy of the film or container through the use of corona treatment or flame treatment.

In various aspects, the types of polypropylene that can be useful in the inventive compositions described herein can include polypropylene homopolymer and copolymers of propylene and ethylene, for example random and heterophasic (or impact) copolymers.

In another aspect, other polypropylene compositions can be used alone or in combination with any of the compositions recited herein. In another aspect, the inventive polypropylene compositions can comprise one or more impact modifiers such as ethylene-propylene-diene monomer copolymers (EPDM), copolymers of ethylene with higher alpha-olefins (such as ethylene-octene copolymers), polybutadiene, polyisoprene, styrene-butadiene copolymers, hydrogenated styrene-butadiene copolymers, styrene-isoprene copolymers, and hydrogenated styrene-isoprene copolymers. In another aspect, the inventive polypropylene compositions can further comprise polymer additives known in the art, including but not limited to hindered phenolic antioxidants, phosphorus based secondary antioxidants (e.g. phosphites and phosphonites), thioethers, hydroxylamines, nitrones, amine-N-oxides, alkylated diphenylamines, acid neutralizers (metal soaps, metal oxides, and the like as well as mixtures), metal deactivators, ultraviolet absorbers, hindered amine light stabilizers, benzoate light stabilizers, lubricants, anti-scratch additives, fluorescent whitening agents, and many others. These additional polymer additives are described in “Plastic Additives Handbook”, 5th ed., H. Zweifel, Ed., Hanser Publishers, Munich, 2001, which is incorporated herein by reference. The additional polymer additives may be incorporated into the polymeric materials as part of the additive mixtures of the present invention or as separate components.

In another aspect, various types of polypropylene-based resins can be used as the starting base resin. The propylene-based polymers, as referred to herein, contain at least one propylene unit. The polymer may be a homopolymer of polypropylene, a random or block copolymer of propylene and another α-olefin or a mixture of α-olefins, or a blend of a polypropylene homopolymer and a different polyolefin. For the copolymers and blends, the α-olefin may be polyethylene or an α-olefin having 4 to 12 carbon atoms. In one aspect, the α-olefin contains containing 4 to 8 carbon atoms, such as butene-1 or hexene-1. In the case of copolymers, it is desirable that at least 50 mol % of the copolymer is formed from propylene monomers. In one aspect, the copolymer may contain up to 40 mol %, and up to 50 mol %, of ethylene or an alpha-olefin having 4 to 12 carbon atoms, or mixtures thereof. Blends of propylene homopolymers with other polyolefins, such as high density polyethylene, low density polyethylene, or linear low density polyethylene and polybutylene can be used herein.

In one aspect, the propylene-based polymer has a melt flow rate (MFR) sufficiently high for facile and economical production of the injection molded or extruded parts, but not so high as to produce a molded part with undesirable physical properties. In one aspect, the MFR should be in the range of from about 0.5 decigrams/minute to about 200 decigrams/minute (dg/min), for example, about 0.5, 0.6, 0.7, 0.8, 0.9, 1, 2, 3, 4, 5, 6, 7, 8, 9, 10, 12, 14, 16, 18, 20, 25, 50, 75, 100, 125, 150, 175, or 200; or from about 2.0 dg/min to about 100 dg/min, for example, about 2, 3, 4, 5, 6, 7, 8, 9, 10, 13, 16, 19, 21, 23, 25, 27, 29, 31, 33, 35, 37, 39, 41, 43, 45, 47, 49, 51, 53, 55, 57, 59, 61, 63, 65, 67, 69, 71, 73, 75, 77, 79, 81, 83, 85, 87, 89, 91, 93, 95, 97, 99, or 100 dg/min, as measured by ASTM-1238. In one aspect, it can be disadvantageous for the MFR of the resin to exceed about 200 dg/min. In such an aspect, the molded part can become brittle or have reduced tensile strength. When the MFR is less than 0.5 dg/min, difficulties can be encountered in extruding or molding the part due to the high melt viscosity. In another aspect, it can also be possible to blend polypropylene-based polymers of different melt flow rates to obtain a final average MFR that is in the desired range.

In one aspect, the propylene-based polymer is a polypropylene homopolymer or blend thereof. In a further aspect, the propylene-based polymer comprises polypropylene. In a further aspect, the propylene-based polymer comprises a random or block copolymer selected from the group consisting of copolymers of propylene and ethylene, copolymers of propylene an α-olefin with 4 to 12 carbon atoms, copolymers of polypropylene and a mixture of α-olefins with 4 to 12 carbon atoms, and copolymers of propylene and ethylene and one or more α-olefins with 4 to 12 carbon atoms.

In another aspect, the propylene-based polymer can optionally be admixed with one or more additives, including lubricants, antioxidants, ultraviolet absorbers, radiation resistance agents, and antistatic agents. In another aspect, care should be taken to avoid incorporation of any additives that function as alpha nucleating agents such as sodium benzoate, and commercial alpha nucleants such as the sorbitol compound from Milliken Chemical Company known as Millad 3988, the alpha nucleant HPN-68, or the alpha nucleating agents NA-11 and NA-21 from The Adeka Chemical company.

If beta nucleation is used to produce the microporous oriented film or a microporous thermoformed container, then the polypropylene resin must contain a beta nucleating agent. The extruded pre-cursor sheet used to make the microporous film or the thermoformed part contains a resinous polymer of propylene and an effective amount of beta spherulites. The beta spherulites in the extruded film are produced by the incorporation of a beta nucleating agent in the polymer. Not wishing to be bound by theory, during the film casting process, beta spherulites begin growing from the beta nucleant particles as the melt cools.

Crystalline polypropylene (also known as “isotactic polypropylene”) is capable of crystallizing in three polymorphic forms: the alpha, beta, and gamma forms. In melt-crystallized material the predominant polymorph is the alpha or monoclinic form. The beta or pseudohexagonal form generally occurs at levels of only a few percent, unless certain heterogeneous nuclei are present or the crystallization has occurred in a temperature gradient or in the presence of shearing forces. The gamma or triclinic form is typically only observed in low-molecular weight or stereoblock fractions that have been crystallized at elevated pressures. Each component used to make the tape yarns described herein is discussed in detail below.

As discussed above, beta-nucleating agents are used to produce beta-spherulites during the formation of the extruded sheets. The beta-nucleating agent can be any inorganic or organic nucleating agent that can produce beta-spherulites in the melt extruded sheet or film. In one aspect, the beta-nucleating agent can include:

(a) the gamma-crystalline form of a quinacridone colorant Permanent Red E3B, herein referred to as “Q-dye.” The structural formula for Q-dye is:

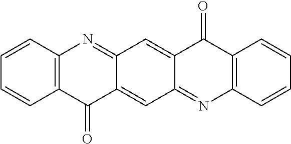 [SMILES: O=C1c2ccccc2N=c2cc3c(cc21)=Nc1ccccc1C3=O]

(b) the bisodium salt of o-phthalic acid;
(c) the aluminum salt of 6-quinizarin sulfonic acid;
(d) isophthalic or terephthalic acids; and
(e) N′,N′-dicyclohexyl-2,6-naphthalene dicarboxamide, also known as NJ Star NU-100, developed by the New Japan Chemical Co.

In another aspect, the beta-nucleating agents disclosed in German Patent DE 3,610,644 can be used herein. This beta-nucleating agent is prepared from two components, (A) an organic dibasic acid, such as pimelic acid, azelaic acid, o-phthalic acid, terephthalic acid, and isophthalic acid; and (B) an oxide, hydroxide or an acid salt of a metal of Group II, such as magnesium, calcium, strontium, and barium. The acid salt of the second component (B) may be derived from an organic or inorganic acid, such as a carbonate or stearate. The composition may contain up to 5 wt % of Components A and B (based the weight of the polymer) and preferably contains up to 1 wt % of Components A and B.

In one aspect, the beta-nucleating agent can be 5,12-dihydro-quino(2,3b)acridine-7,14-dione with quino(2,3b)acridine-6,7,13,14 (5H, 12H)-tetrone, N,N′-dicyclohexyl-2,6-naphtalene dicarboxamide and salts of dicarboxylic acids with at least 7 carbon atoms with metals of group IIa of the periodic table. It is also contemplated that any mixture of these compounds can be used as the beta-nucleating agent.

The properties of the extruded sheet and the oriented film or thermoformed container made from the extruded sheet can vary depending upon the selection and concentration of the beta-nucleating agent. The amount of the beta-nucleating agent depends on the effectiveness of the particular beta-nucleating agent in inducing beta-crystal formation, and the thermal conditions under which the extruded sheet is produced. In one aspect, the amount of beta-nucleating agent is sufficient to produce an extruded precursor sheet having a beta crystal content measured using wide angle x-ray diffraction (WAXD) having a K-value in the range of 0.1 to 0.95. In one aspect, the concentration of the beta-nucleating agent is from 0.5 to about 5,000 ppm.

In one aspect, the beta-nucleating agent is Q-dye, which is present in the composition in an amount ranging from 0.1 to about 100 ppm, or from 0.1 to about 50 ppm. The resulting part has a K-value in the range of about 0.1 to 0.95, or from about 0.2 to 0.85. In another aspect, the beta-nucleant is quinacridone colorant Permanent Red E3B and is present in the composition at a level of about 0.5 to about 50 ppm, based on the weight of the resinous polymer of propylene.

The nucleating agents are typically in the form of powdered solids. To efficiently produce beta-crystallites, it is desirable that the powder particles be less than 5 microns in diameter, preferably no greater than 1 micron in diameter.

The beta-spherulite content of the extruded precursor film can be defined qualitatively by optical microscopy, or quantitatively by x-ray diffraction or thermal analysis. In the optical microscopy method, a thin section microtomed from the extruded precursor film is examined in a polarizing microscope using crossed polars. The beta-spherulites show up much brighter than the alpha spherulites due to the higher birefringence of the beta-spherulites.

In the x-ray diffraction method the diffraction pattern of the tape yarn is measured, and the heights of the three strongest alpha phase diffraction peaks, H110, H130 and H040 are determined, and compared to the height of the strong beta phase peak, H300. An empirical parameter known as “K” (herein referred to as the “K-value”) is defined by the equation:

K=(H300)/[(H300)+(H110)+(H040)+(H130)]

The K-value can vary from 0, for a sample with no beta-crystals, to 1.0 for a sample with all beta-crystals.

Thermal analysis of the tape yarn can be characterized by Differential Scanning calorimetry (DSC) to determine the beta-spherulite nucleation effects. Parameters which are measured during the first and second heat scans of the DSC include the crystallization temperature, Tₑ, the melting temperature, Tₘ, of the alpha (α) and beta (β) crystal forms, and the heat of fusion, ΔH_{f}, including both the total heat of fusion, ΔH_{f-tot}, and the beta melting peak heat of fusion, ΔH_{f-beta}. The melting point of the beta-crystals is generally about 10-15° C. lower than that of the alpha crystals. The magnitude of the ΔH_{f-beta}. parameter provides a measure of how much beta crystallinity is present in the sample at the start of the heat scan. Generally, the second heat of fusion values are reported, and these values represent the properties of the material after having been melted and recrystallized in the DSC at a cool-down rate of 10° C./minute. The first heat thermal scans provide information about the state of the material before the heat history of the processing step used to make the samples had been wiped out. It is desirable that the first heat thermal scan show a distinct melting peak for the beta crystal phase, and the heat of fusion of the beta crystal phase be at least 5% of the total heat of fusion of the alpha and beta crystal phases. Alternatively, the extruded precursor film can have a prominent melting peak for the beta crystal phase on the 1^{st} heat scan when a sample of the film is placed in a DSC and heated at a rate of 10° C. per minute.

Turning to the propylene-based polymer, various types of polyolefin resins can be used as the starting base resin. The propylene-based polymers as referred to herein contain at least one propylene unit. The polymer may be a homopolymer of polypropylene, a random or block copolymer of propylene and another α-olefin or a mixture of α-olefins, or a blend of a polypropylene homopolymer and a different polyolefin. For the copolymers and blends, the α-olefin may be polyethylene or an α-olefin having 4 to 12 carbon atoms. In one aspect, the α-olefin contains containing 4 to 8 carbon atoms, such as butene-1 or hexene-1. In the case of copolymers, it is desirable that at least 50 mol % of the copolymer is formed from propylene monomers. In one aspect, the copolymer may contain up to 40 mol %, and up to 50 mol %, of ethylene or an α-olefin having 4 to 12 carbon atoms, or mixtures thereof. Blends of propylene homopolymers with other polyolefins, such as high density polyethylene, low density polyethylene, or linear low density polyethylene and polybutylene can be used herein.

It is desirable that the propylene-based polymer has a melt flow rate (MFR) great enough for facile and economical production of the extruded sheet, but not so great as to produce a final oriented film or thermoformed container with undesirable physical properties. In one aspect, the MFR should be in the range of about 0.1 to 50 decigrams/minute (dg/min), or from about 0.5 to 10 dg/min as measured by ASTM-1238. When the MFR of the resin exceeds 100 dg/min, disadvantages are caused by the brittleness of the oriented film or thermoformed container, or the inability to process the extruded sheet into an oriented film or thermoformed container. When the MFR is less than 0.1 dg/min, difficulties are encountered in extruding the sheet due to the high melt viscosity. It is also possible to blend polypropylene-based polymers of different melt flow rates to obtain a final average MFR which is in the desired range.

In one aspect, the propylene-based polymer is a polypropylene homopolymer or blend thereof. In a further aspect, the propylene-based polymer comprises polypropylene. In a further aspect, the propylene-based polymer comprises a random or block copolymer selected from the group consisting of copolymers of propylene and ethylene, copolymers of propylene an α-olefin with 4 to 12 carbon atoms, copolymers of polypropylene and a mixture of α-olefins with 4 to 12 carbon atoms, and copolymers of propylene and ethylene and one or more α-olefins with 4 to 12 carbon atoms.

The propylene-based polymer can be admixed as needed with a variety of additives, including lubricants, antioxidants, ultraviolet absorbers, radiation resistance agents, antistatic agents, coupling agents, and coloring agents, such as pigments and dyes. If a co-extruded sheet is produced having a second layer that is opaque, then this second layer can contain opaque pigments such as TiO2 or carbon black, or filler particles such as calcium carbonate or talc. Standard quantities of the additives are included in the resin, although the addition of any minerals or abrasive additives should be kept to a minimum. Care should be taken to avoid incorporation of other nucleating agents or pigments that act as nucleating agents since these materials may prevent the proper nucleation of beta-spherulites. For example, alpha nucleating agents that should omitted from the formulation include sodium benzoate, lithium benzoate, NA-11 from Amfine, which is the sodium salt of 2,2′-methylene bis(4,6-di-tert-butylphenyl)phosphate, and sorbitol clarifiers, such as Millad 3988 from Milliken Chemicals (i.e., bis(3,4-dimethylbenzylidene)sorbitol).

Preferred antistatic agents include alkali metal alkane sulfonates, polyether-modified (i.e., ethoxylated and/or propoxylated) polydiorganosiloxanes, and substantially linear and saturated aliphatic tertiary amines containing a C₁₀₋₂₀ aliphatic radical and substituted by two C₁₋₄ hydroxyalkyl groups, such as N,N-bis-(2-hydroxyethyl)-alkyl amines containing C₁₀₋₂₀, preferably C₁₂₋₁₈, alkyl groups.

A number of techniques can be used to make the extruded sheets described herein. In one aspect, the extruded sheet can be made by the following steps: (1) melt compounding a propylene-based polymer containing an effective amount of beta-nucleating agent capable of producing beta spherulites in the extruded sheet or film, together with optional stabilizing additives, in order to produce pellets of a beta-nucleated resin; and (2) feeding the pellets into a film extruder in order to produce the extruded sheet.

In another aspect, the extruded sheet can be produced by mixing pellets of a masterbatch containing the beta-nucleating agent with pellets of a propylene-based polymer that does not contain any alpha-nucleating agents. This pellet mixture can then be fed into the sheet extruder in the manner described in the previous paragraph in order to produce a final extruded sheet.

In general, the beta-nucleating agent can be dispersed in the propylene-based polymer by any suitable procedure normally used in the polymer art to effect thorough mixing of a powder with a polymer resin. For example, the beta-nucleating agent can be powder blended with the propylene-based polymer in powder or pellet form or the beta-nucleating agent can be slurried in an inert medium and used to impregnate or coat the propylene-based polymer resin in powder or pellet form. Alternatively, powder and pellets can be mixed at elevated temperatures by using, for example, a roll mill or multiple passes through an extruder. A preferred procedure for mixing is the blending of the beta-nucleating agent powder and base propylene-based polymer resin pellets or powder and melt compounding this blend in an extruder. Multiple passes through the extruder may be necessary to achieve the desired level of dispersion of the beta-nucleating agent. Ordinarily, this type of procedure can be used to form a masterbatch of pelletized resin containing sufficient beta-nucleating agent so that when a masterbatch is let down in ratios of 10/1 to 200/1 (polymer to beta-nucleating agent) and blended with the base resin, the desired level of beta-nucleating agent is obtained in the final product.

In one aspect, a concentrate composed of the beta-nucleating agent and a propylene-based polymer can be used to fabricate the extruded sheet. In one aspect, the concentrate is a highly loaded, pelletized propylene-based polymer resin containing a higher concentration of nucleating agent than is desired in the final product. The nucleating agent can be present, for example, in the concentrate in a range of from about 0.005% to about 2.0% (about 50 ppm to about 20,000 ppm), more preferably in a range of from about 0.0075% to about 1% (about 75 ppm to about 10,000 ppm). Typical concentrates can be blended with a non-nucleated propylene-based polymer in the range of from about 0.1% to about 10% of the total polypropylene content of the extruded sheet or film, for example, from about 0.5% to about 5.0% of the total polypropylene content of the extruded film or sheet. The final product can thus contain from about 0.00005% to about 0.1% (about 0.5 ppm to about 1000 ppm), for example, from about 1 ppm to about 200 ppm. A concentrate can also contain other additives such as stabilizers, pigments, and processing agents, but does not usually contain any additives which significantly nucleate the alpha crystal form of polypropylene.

In one aspect, the polymer concentrate can include a propylene-based polymer, and at least one beta-nucleating agent in a concentration of from about 0.01% to about 2.0% based upon the weight of the concentrate. In a yet further aspect, the beta-nucleating agent is present in a concentration of from about 0.1 to 200 ppm and has the structural formula:

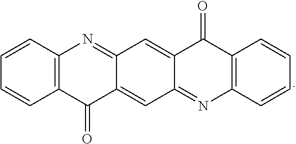 [SMILES: O=C1c2ccccc2N=c2cc3c(cc21)=Nc1ccccc1C3=O]

In another aspect, a concentrate of Q-dye masterbatch can be formed by first adding a sufficient amount of the quinacridone dye to the polypropylene resin to form a polypropylene resin containing 40% of the quinacridone dye. 3% of this concentrate is then extrusion compounded with an additional 97% of polypropylene to make a new concentrate that contains 1.2% of the quinacridone dye (“the 1.2% concentrate”). A third compounding step is then performed where 3% of the 1.2% concentrate is blended with 97% of polypropylene and to make a new concentrate that contained 0.036% of the quinacridone dye. This final concentrate is then added at a 2% level to the base polypropylene used to make the extruded film or sheet containing 0.00072% or 7.2 ppm of the quinacridone dye.

After the beta-nucleating agent and propylene-based polymer have been melt-blended, the blend is extruded through a slit die to produce an extruded sheet. In one aspect, the extrusion step can be a melt extrusion slit-die or T-die process. Extruders used in such a melt-extrusion process can be single-screw or twin-screw extruders. Preferably, such machines are free of excessively large shearing stress and are capable of kneading and extruding at relatively low resin temperatures.

For producing a coextruded multi-layer film with one layer that contains a beta-nucleated resinous polymer, one extruder may be used to extrude a part of the beta-spherulite nucleated resin. A second extruder may be used to extrude a layer of nucleated or non-nucleated polymer resin, which is located on at least one side of the nucleated resin. This second layer can contain opaque pigments and fillers. Alternatively, more than one extruder can be used to supply molten polymer to a coextrusion die. This allows two or more distinct polymer layers to be coextruded from a given slit-die.

The temperature at the die exit should be controlled, such as through the use of a die-lip heater, to be the same as or slightly higher than the resin melt temperature. By controlling the temperature in this manner, “freeze-off” of the polymer at the die lip is prevented. The die should be free of mars and scratches on the surface so that it produces a film with smooth surfaces. The thickness of the extruded film can be in the range of 1 to 20 mils, 2 to 18 mils, 3 to 16 mils, or 4 to 14 mils where 1 mil is one-one thousandth (0.001) of an inch.

In a further aspect, the method for making the extruded sheet further includes the step of casting the extruded propylene-based polymer sheet onto a heated chill roll. In this aspect, the roll temperature can be adjusted to produce a sheet containing high levels of beta crystallinity (e.g., a K-value obtained by x-ray diffraction analysis of 0.1 to 0.95). For example, the cast roll temperature can be in excess of 75° C. (170° F.).

In a further aspect, the method for making the extruded sheet further includes the step of casting the extruded polypropylene-based sheet into a heated water bath. In this respect, the water bath temperature can be adjusted to produce a sheet containing high levels of beta crystallinity (e.g., a K-value obtained by x-ray diffraction analysis of 0.1 to 0.95). For example, the water bath temperature can be in excess of 75° C. (170° F.).

In a further aspect, the method further comprises the step of orienting the extruded sheet in the machine direction (MD) by heating this sheet to a temperature in the range of 50° C. to 130° C. by passing the sheet over a series of heated rollers, where the orientation takes place as the sheet passes from a slow roller to a fast roller. The draw ratio of the oriented film is the ratio of the speed of the fast roller to the speed of the slow roller, if the two rollers have the same diameter. This orientation step can also be performed by drawing the film through an air oven, with the air temperature set so as to heat the film to a temperature in the range of 50° C. to 130° C. when the drawing takes place. The draw ratio can be in the range of 1.2:1 to 8:1, or 4:1 to 7:1. The final oriented tape can have a thickness in the range of 0.1 to 10, 0.2 to 8 mils, or 0.5 to 7 mils. The orientation step is done under conditions where the final oriented film ranges in appearance from translucent to opaque. Generally lower draw temperatures produce films with greater opacities. Lower draw temperatures also produce oriented films with higher levels of microvoiding and a lower density. The increased microvoiding is desirable, since it enhances the visibility of the laser etched printing on the final film. Not wishing to be bound by theory, after this precursor extruded film is stretched, the beta crystals present in the film transform into alpha crystals, where the final tape yarn contains only an alpha crystal phase.

The oriented film can also be produced by biaxially stretching the precursor extruded sheet. This biaxial stretching can be done sequentially by feeding the mono-oriented film into a tenter frame oven such as that used to produce biaxially oriented polypropylene film (BOPP). This oven contains moving rails with clips attached to them that grip the edges of the film as it enters the tenter frame. As the film is heated in the oven the rails diverge causing the film to be stretched in the transverse direction. The transverse draw ratios can range from 1.5:1 to as high as 10:1. During the stretching process in the tenter frame additional voids are produced and existing voids are expanded. These changes cause a further decrease in the density of the film and a corresponding increase in opacity compared to final mono-oriented films having the same final thickness.

Alternatively, the biaxial stretching can be achieved by first extruding a cylindrical tube, and then stretching the solidified tube simultaneously in both directions through by re-heating it and using air pressure. This process is sometimes referred to as the “double bubble” process.

In addition to being opaque, the final oriented film possesses high levels of microvoids. Not wishing to be bound by theory, the beta-nucleating agents used herein can induce microvoid formation in the film during the stretching of the precursor extruded sheet to produce the final oriented film. Increased microvoid formation results in films that have a lower density. This density reduction can range from as low as 2% in mono-oriented film to as much as 70% in biaxially oriented film.

If the final product is a thermoformed container, the extruded sheet would be fed into an oven where it is heated to a temperature where it is soft enough to thermoform, but not so high as to cause the beta crystals in the sheet to melt. For homopolymer polypropylene this temperature range would generally be from about 140° C. to 150° C. During the forming stem the heated sheet is fed between two halves of a mold containing female cavities on one side and movable plugs on the other side. After the mold is closed, the plugs are driven down into the sheet, and a combination of positive air pressure is applied to the plug side of the sheet, and a vacuum is also commonly used on the cavity side of the sheet. This combination of plug-assist with air pressure and vacuum are used to force the sheet into the mold so that it conforms to the shape of the cavity. Since this forming process results in stretching the sheet below the melting point of the beta crystal phase, the beta crystals transform into alpha crystals, and microvoids form in the thermoformed part. As in the case of the oriented film, these microvoids cause the final container to take on a white/opaque appearance due to light scattering from the voids, and then density of the container walls also decreases.

It is also possible to produce an extruded, injection molded, or thermoformed product that contains voids using a foaming process. Other processes such as extrusion blow molding, injection blow molding, blown film production, cast film production, and oriented film production may also be used. In these cases one is not restricted to the use of polypropylene, and any clear or translucent thermoplastic can be used, including both semi-crystalline and amorphous materials. This includes, but is not restricted to polyethylene, polypropylene, polystyrene, polycarbonate, polyacrylate, polysulfones, polyamides, polyesters, etc, and there associated copolymers. Also biopolymers such as polylactic acid (PLA), and related copolymers can be used.

The voids that exist in these materials are produced using a foaming process. Chemical foaming agents such sodium bicarbonate plus citric acid, or azodicarbonamide compounds can be used to produce the foamed structure in the final part. These types of compounds undergo chemical reactions in the molten polymer to liberate gases which form bubbles one the pressure on the melt drops after an extruded part exits the extruded or a molded part solidifies in the mold. Careful control of the bubble size is required so that the final voids in the part are not so large that the part has a poor appearance or poor physical properties. Often bubble nucleating agents such as talc are used reduce the size of the bubbles in the polymer melt.

Another method of using a foaming process to produce voids or bubbles in the final part is to introduce inert gases such as nitrogen or carbon dioxide into the polymer melt while the polymer is under pressure in the extruder. These inert gases such as carbon dioxide can also be introduced in the form of supercritical fluids. These gases dissolve in the polymer melt and they remain dissolved as long as the melt is under high pressure. As soon as the pressure drops when the polymer exits from the extruder die or when the polymer is injected into a mold, the dissolved gases come out of solution, and form bubbles in the melt. When the melt solidifies these bubbles become voids in the final part. Since the voids scatter light, the final part has a white/opaque appearance.

A particularly preferred method of generating these voids is to use the Mucell process. This patented process uses supercritical fluids in a specially designed extruder to produce large numbers of very small voids. The small size of these voids produced relative to that of conventional foaming processes, leads to final parts with improved appearance and improved physical properties. The small void size also facilitates the use of the laser thermal printing technique by allowing smaller and more detailed printing to be achieved.

The microporous films of the present invention can also contain other layers that are not microporous. In particular, these other layers can be opaque and they can also contain pigments, colorants, minerals, and fillers. These other film layers can be produced using co-extrusion or they can be laminated or coated onto the microporous film layer after the pores have been produced. One side of the porous film layer can also be coated with an adhesive that contains pigments. It is also possible to coat the microporous film layer with a thin metallic layer produced using any commercial metalizing process. When a laser is used to print on the microporous film layer by heating the porous film layer to a temperature that is sufficiently hot enough to cause the pores to collapse, the opaque or pigmented layer on one side of the porous film will become visible in the regions where the pores have collapsed. When this film is viewed from the side that is opposite to the side that contains the pigmented film or adhesive layer, the color of this pigmented layer will appear as if it had been printed on this side of the film due to the transparency of the porous film in the regions that have been heat treated with the laser. Since no inks are actually used this printing effect, the printing will be resistant to exposures with solvents that would normally remove or degrade ink-based printing. Also this laser-based printing of the film does not consume any inks or solvents, and no drying processes are needed to remove any solvents.

A laser or other source of focused energy can be made to impinge on the surface of the porous film so that the film is heated to a temperature that is sufficiently hot enough to melt or soften the porous film so that the voids or pores will collapse thereby causing the film in these melted or softened regions to become transparent. Any laser that heats the plastic film can be used. This includes carbon dioxide or CO₂ lasers

### EXAMPLES

A microporous polypropylene film was produced by blending a masterbatch containing a beta nucleating quinacridone pigment with a non-nucleated polypropylene impact copolymer resin. The masterbatch contained 0.01% of the quinacridone pigment identified as pigment violet 19 (CAS #1047-16-1) dispersed in a 12 melt flow rate polypropylene homopolymer resin. 2% of this masterbatch was blended with 98% of an impact copolymer polypropylene resin and then an extruded sheet was cast onto the surface of a heated chill roll with a surface temperature of about 95° C. The extruded sheet thickness was about 20 mils (0.5 mm). This sheet was then oriented in the machine direction by stretching it at about 100° C. using a draw ratio of 5:1 to produce a microporous film having a final thickness of about 5.5 mils.

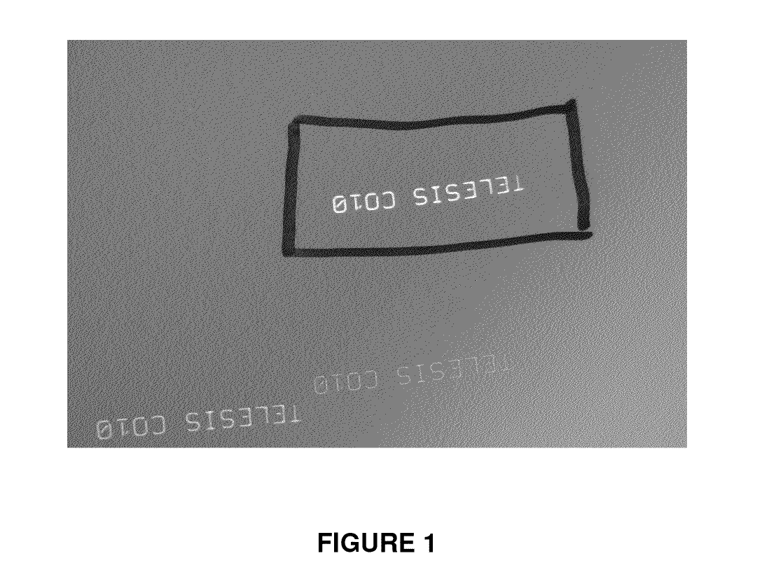

A sample of this microporous film was exposed to a 10 watt CO₂ (model CO10) from Telesis Corporation laser for various time periods. The film was exposed to the laser for 0.563 seconds. The appearance of this film after the laser treatment using back-lighting is illustrated in FIG. 1. The brightness seen in the laser-etched region demonstrates that the film has turned clear in this region.

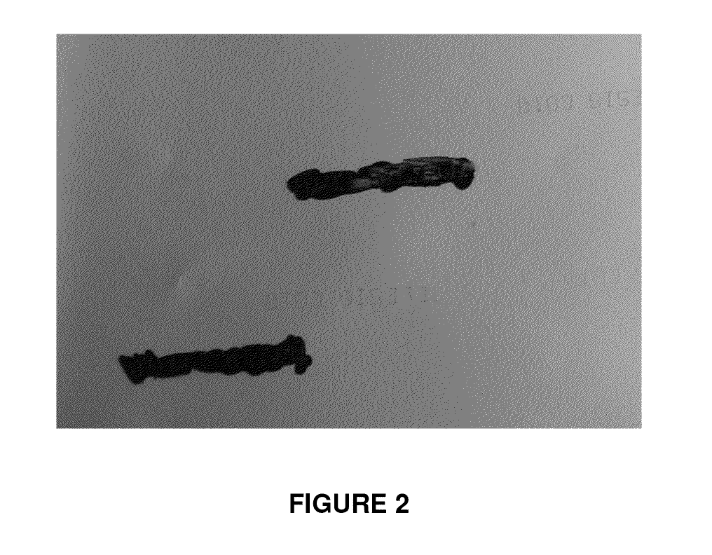

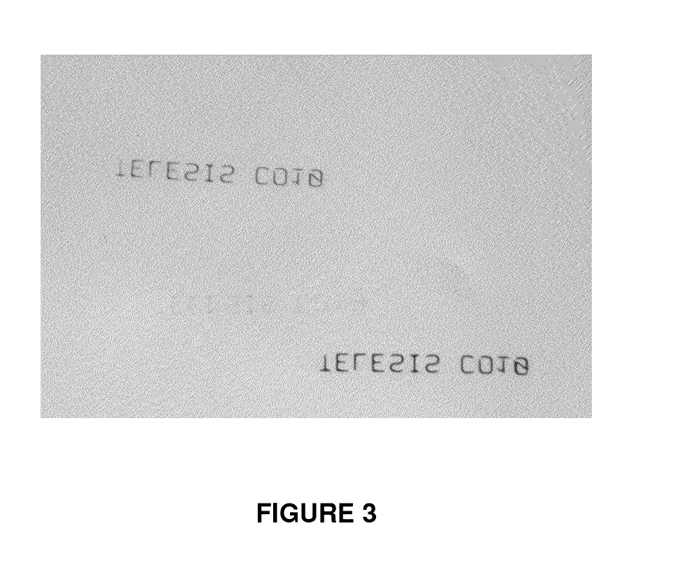

In another example the porous film was also treated with the same CO₂ laser and then a black marker was used of cover one side of the treated film with black ink in the region that was laser treated. The appearance of the black ink-marked side of the film is illustrated in FIG. 2. The appearance of the opposite side of the ink-marked film is illustrated in FIG. 3. FIG. 3 shows that the ink applied to the opposite side of the film gives the appearance of sharp printing on the non-inked side of the film. If the inked side of the film contained either a colored co-extruded film or an adhesive containing a colored pigment, the print appearance would have been similar.

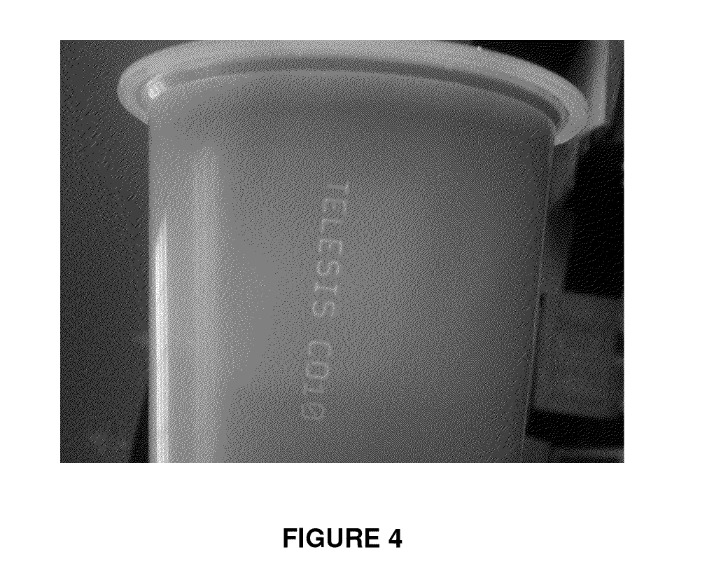

In another example a thermoformed polypropylene cup was produced using beta nucleation. The cup had an opaque/white appearance due to the presence of microvoids in the sidewall of the cup. The cup did not contain any fillers or pigment. These microvoids were produced during the forming process in a manner that is similar to what occurs when a beta nucleated polypropylene sheet is oriented in the solid state to produce a microporous film. In FIG. 4 the appearance of the cup is shown after being exposed to the CO₂ laser. In a similar manner to the film, the laser treated portion of the cup becomes clear. If this cup had been filled with a colored food product such as orange juice or tomato juice, the color of the food product would be visible when the filled cup is examined. This visibility can be used to enhance the consumer appeal of the packaged product.

What is claimed:

1. A process for printing on a microporous polymer substrate using a laser to melt or soften the substrate so that the pores collapse and produce clear regions where light can pass through the substrate

2. The process of claim 1 wherein the substrate comprises a clear thermoplastic polymer

3. The process of claim 2 wherein the substrate comprises a thermoplastic polypropylene resin

4. The process of claim 3 wherein the thermoplastic polypropylene resin comprises a homopolymer, heterophasic block copolymer, random copolymer, or combination thereof

5. The process of claim 4 in which an extruded pre-cursor film or sheet made from the thermoplastic polypropylene resin has a beta crystal content of at least 5% as measured by the heat of fusion of the beta crystal melting peak on the first heat scan using differential scanning calorimetry using heating and cooling rates of 10° C./min.

6. The process of claim 5 wherein the pores are produced by stretching a polypropylene pre-cursor film or sheet in the solid state below the melting point of the beta crystal phase

7. The product produced by the process in claim 1.

8. The product of claim 7 wherein the substrate comprises a clear thermoplastic polymer

9. The product of claim 8 wherein the substrate comprises a thermoplastic polypropylene resin

10. The product of claim 9 wherein the thermoplastic polypropylene resin comprises a homopolymer, heterophasic block copolymer, random copolymer, or combination thereof.

11. The product of claim 10 in which an extruded pre-cursor film or sheet made from the thermoplastic polypropylene resin has a beta crystal content of at least 5% as measured by the heat of fusion of the beta crystal melting peak on the first heat scan using differential scanning calorimetry using heating and cooling rates of 10° C./min.

12. The product of claim 11 wherein the pores are produced by stretching a polypropylene pre-cursor film or sheet in the solid state below the melting point of the beta crystal phase

13. The product of claim 12 in which the stretching is done in one direction

14. The product of claim 12 in which the stretching is done biaxially

15. The product of claim 12 in which an extruded sheet is thermoformed into the final container

16. The product of claim 12 in which the pre-cursor film or sheet comprises at least two layers with one of the layers also containing a pigment or a filler

17. The product of claim 12 in which an adhesive containing a pigment is applied to one side of the final stretched film

18. The thermoplastic composition of claim 8, further comprising a chemical foaming agent and/or a physical blowing agent incorporated into the thermoplastic resin so as to produce an extruded, blown, or injection molded product that contains a cellular structure

19. The product of claim 18 in which the extruded sheet or film contains at least two layers with one of those layers also containing a pigment or a filler

20. The product of claim 18 in which an adhesive containing a pigment is applied to one side of the final product
